(19) United States
(12) Patent Application Publication
(10) Pub. No.: US 2024/0134948 A1
(43) Pub. Date: Apr. 25, 2024

(54) BIOMETRICALLY AUTHENTICATED WIRELESS IDENTIFICATION DEVICE

(71) Applicant: JABAA, LLC, Bangor, ME (US)

(72) Inventor: Michael L. Smith, Sebastian, FL (US)

(73) Assignee: JABAA, LLC, Bangor, ME (US)

(21) Appl. No.: 17/789,641

(22) PCT Filed: Dec. 16, 2020
(86) PCT No.: PCT/US20/65404

§ 371 Date: Nov. 15, 2022

Related U.S. Application Data
(60) Provisional application No. 62/954,423, filed on Dec. 28, 2019.

(51) Int. Cl. G06F 21/32; G06F 21/35; G06Q 20/40; H04W 12/06

(52) U.S. Cl. CPC G06F 21/32; G06F 21/35; G06Q 20/40145; H04W 12/06

(57) ABSTRACT

A biometrically-authenticated identification device is provided, comprising: a processor; a persistent memory; a transient memory; a persona data store comprising configuration or operational settings of the biometrically-authenticated wireless identification device; a biometric input device; a pre-enrolled biometric data store; a biometric verification module in electronic communication with the biometric input device, the biometric verification module being configured to compare stored biometric indicia of a user of the biometrically-authenticated identification device with information provided by the biometric input device, the biometric verification module further being in electronic communication with a pre-enrolled biometric data store; and a wireless transceiver.

### 1 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2019, Biometric Associates, Inc.

### 2 BACKGROUND OF THE TECHNOLOGY

### 2.1 Field of the Technology

The exemplary, illustrative, technology herein relates to systems, software, and methods for a biometrically-authenticated wireless identification device including a biometric authentication module and a wireless communications module that transmits in the blind broadcast messages corresponding to a particular user and/or the manner in which a particular user authenticates to the device. In some embodiments, the biometrically-authenticated wireless identification device functions are integrated into an off the shelf or specialty mobile device such as a smartphone using standard components and configured with specialty software or is implemented as a customized biometrically-authenticated wireless identification card or badge. The technology herein has applications in the areas of identification and access control.

### 2.2 The Related Art

Biometric-authenticated smart cards are becoming commonplace for identifying users for access control and financial transaction purposes. However, they still require direct interaction with access control systems or financial transaction terminals in order to make them effective for everyday use. Current systems do not provide for secure operation at a distance (e.g. over the air), a plurality of users for the device, multiple security domains requiring differing authentications within a single device, nor do they support robust association of users, their personalized information, and the specific methods of communication required to make them useful in varying deployment scenarios.

Bluetooth-enabled tracking devices (e.g. smart phones, tokens, and badges) are becoming commonplace for monitoring the real-time location (RTL) of individuals within a facility. The location of the individual token is established by monitoring the Bluetooth beacon that is broadcast by the Bluetooth radio within the tracking device. However, the identity of the possessor of these devices is not known to the receiver of the tracking messages. Adding biometric authentication to the tracking device confirms the identity of the individual possessing the tracking device, but does not alter the nature of the beaconing signals transmitted by the device, limiting their use to NFC and/or wired connections. Current Real Time Location Systems (RTLS) do not provide the ability for the individual possessing the RTLS tracking device to broadcast a Bluetooth beacon containing a differing data set depending upon the device's operational status and/or the user's condition.

A known Bluetooth-enabled access card is configured to transmit a connectionless message that includes preconfigured information such as a MAC address associated with the device, an access card specific QUID, or a predefined encoded URL. These signals contain pre-determined, static content and have limited usefulness for authentication and authorization purposes as they either do not identify the user currently using the card and/or are easily spoofed. Therefore, a Bluetooth-enabled access control point or other wireless device configured to receive and process connectionless messages must open a separate two-way communication session with the card to determine additional information that uniquely identifies the user.

### 2.3 The Technology of the Invention

The technology of the invention comprises a biometrically-authenticated wireless identification device that identifies a current user using one or more biometric techniques, such as a fingerprint or iris scanner, a face identifier, or a voiceprint identifier. In an embodiment, a user authenticates to the biometrically-authenticated wireless identification device by sliding a finger over a finger print scanner, which matches the scanned fingerprint against a previously provisioned fingerprint information associated with one or more sets of communication policy information and personalized user information, then constructs and transmits information uniquely and securely identifying the authenticated user. The biometrically-authenticated wireless identification device then continues to operate to transmit the personalized user information in accordance with the communication policy, and discontinues the transmission when conditions specified by the communication policy(ies) are met. In one aspect, the biometrically-authenticated wireless identification device is activated to transmit Bluetooth connectionless messages, such as Bluetooth Low Energy (BLE) advertising packets, configured with user identification information in accordance with the specified communication policy.

### 3 SUMMARY OF THE TECHNOLOGY

In a first aspect, the invention described herein provides a biometrically-authenticated identification device, comprising: a processor; a persistent memory; a transient memory; a persona data store comprising configuration or operational settings of said biometrically-authenticated wireless identification device; a biometric input device; a pre-enrolled biometric data store; a biometric verification module in electronic communication with said biometric input device, said biometric verification module being configured to compare stored biometric indicia of a user of said biometrically-authenticated identification device with information provided by said biometric input device, said biometric verification module further being in electronic communication with a pre-enrolled biometric data store; and a wireless transceiver. In a more specific embodiment, the biometrically-authenticated identification device is associated with one or more authentication methods and the biometric indicia provisioned for one or more specific authenticated users of the biometrically-authenticated identification device. In still more specific embodiments, the biometrically-authenticated identification device comprises a plurality of the persona data stores.

In other more specific embodiments of the basic description provided above, the biometric input device includes at least one of an iris scanner, voice print recognizer, and a fingerprint scanner. Other more specific embodiments of the basic description provided above, the wireless transceiver is a Bluetooth device, an RFID device, or both. In more specific embodiments among those just described, the wireless transceiver is an RFID transmitter and a Bluetooth radio. In still more specific embodiments, the biometrically-authenticated identification device further includes a personal connectionless message data store. Yet more specific embodiments include those wherein the biometrically-authenticated identification device is configured to transmit a personalized connectionless message. In still more specific embodiments, the personalized connectionless message is transmitted wirelessly. In even more specific embodiments, the personalized connectionless message is configured to indicate one or more of the authentication state of the device, the authenticated user of the device, and the state of the authenticated user. In still more specific embodiments, the personalized connection message is configured according to a specific persona.

Among those other more specific embodiments of the basic description provided above, the wireless transceiver is a Bluetooth device, an RFID device, or both.

In other embodiments of the basic description of the device provided by the invention, the biometrically-authenticated identification device is dimensioned and configured to accept and communicate electronically with an identification card, the identification card providing biometric verification information such that the paring of the biometrically-authenticated identification device with the identification card confirms the identity of the holder of the paired biometrically-authenticated identification device and identification card.

In a second aspect, the present invention provides a method for performing a secure electronic transaction using a biometrically-authenticated identification device, comprising: authenticating the assigned user of the biometrically-authenticated identification device using a biometric identifier for the assigned user; configuring the biometrically-authenticated identification device with a persona corresponding to the assigned user;

transmitting a personalized connectionless message using the biometrically-authenticated identification device; and sending information to perform the secure electronic transaction. In more specific embodiments, the biometrically-authenticated identification device is the biometrically-authenticated identification device described above. In still more specific embodiments, the method of the invention further comprises receiving key session data for the transaction; and generating transaction data corresponding to the transaction. In other more specific embodiments, the method further comprises configuring the biometrically-authenticated identification device with a second persona; transmitting a personalized connectionless message using data associated with the second persona to perform a second secure electronic transaction; and receiving data corresponding to the completion of the second secure electronic transaction.

Other more specific embodiments of the basic method provided by the invention include those wherein the biometrically-authenticated identification device is in an initial powered-down state, and further comprising powering the biometrically-authenticated identification device. Still more specific embodiments further comprise powering down the biometrically-authenticated identification device upon completing the secure electronic transaction. Yet more specific embodiments, includes those wherein the assigned user authenticates with a first biometric indicia and generates a first connectionless message, and further wherein the assignee user authenticates using a second biometric indicia and generates a second connectionless message, the first and second connectionless messages being different and indicating a status of the assigned user.

These and other aspects and advantages will become apparent when the Description below is read in conjunction with the accompanying Drawings.

### 4 BRIEF DESCRIPTION OF THE DRAWINGS

The features of the present technology will best be understood from a detailed description of the technology and example embodiments thereof selected for the purposes of illustration and shown in the accompanying drawings in which:

FIG. 1 depicts a schematic view of an exemplary biometrically-authenticated wireless identification device comprising a biometrically-authenticated wireless identification card according to an embodiment of the invention.

FIG. 2 illustrates exemplary contents of a persistent memory comprising multiple data stores according to an embodiment of the invention.

FIG. 3 depicts alternate versions of an exemplary personalized connectionless message packet, assembled based on two different personas comprising two different user states of the same user according to an embodiment of the invention.

FIGS. 4A and 4B depict general and schematic views of a biometrically authenticated wireless identification badge holder and identity card according to an embodiment of the invention.

FIG. 5 depicts a schematic view of an exemplary biometrically-authenticated wireless identification mobile device according to an embodiment of the invention.

FIG. 6 is a flow chart illustrating a process flow for an exemplary operating mode of a biometrically-authenticated wireless identification device according to an embodiment of the invention.

FIGS. 7A and 7B depict information flows of an exemplary operating mode of a biometrically-authenticated wireless identification device according to an embodiment of the invention.

FIG. 8 depicts a state diagram of an exemplary operating mode of a biometrically-authenticated wireless identification device according to an embodiment of the invention.

FIG. 9 is a flow chart illustrating a process flow for completing a connectionless message based payment transaction between a biometrically authenticated wireless device and a wireless payment terminal.

FIG. 10 illustrates information flow during the connectionless message based payment transaction.

### 5 DEFINITIONS

The following definitions are used throughout, unless specifically indicated otherwise:

| TERM | DEFINITION |
|---|---|
| Authenticated | A user who has successfully authenticated to the |
| user | biometrically-authenticated wireless identification |
| | device. |
| Bluetooth | A standard for the short-range wireless interconnection |
| (BT) | of mobile phones, computers, and other electronic |
| | devices. Currently, the specification is a v5.0, although |
| | any version of the specification that identifies |
| | beaconing behavior may be used. |
| Biometric | A user identity verification process that involves the |
| authentication | scanning or analysis of at least one aspect of the user in |
| | order to verify that the user's identity. |
| Biometric | The information obtained from a user that is used in a |
| indicia | biometric authentication process. |
| Biometric | Comprises, for example, a face recognition template |
| template | that includes features, primitives, graphs, vectors, or |
| | other signatures useful for comparison to corresponding |
| | data extracted from an image captured by the biometric |
| | identification system. Additional or alternative |
| | biometric templates include, for example, a fingerprint |
| | template, face template, iris template, voice print |
| | template, or palm print template. |
| Connectionless | Connectionless messages are wireless signals that are |
| message | broadcast by connectionless presence devices and are |
| | characterized as being broadcast blind, i.e. without |
| | requiring a connection or a known receiver for the |
| | message |

### 6 DESCRIPTION OF SOME EMBODIMENTS OF THE TECHNOLOGY

### 6.1 Overview

A biometrically-authenticated wireless identification device described herein is configured to operate, at a particular time, in a default (unauthenticated) mode, or in accordance with a communications profile associated with one of a plurality of differing authenticated identities. The biometrically-authenticated wireless identification device operates in the unauthenticated mode when it receives a pre-defined activating signal. The activating signal may originate from user activity with the device, or may be externally provided. An example of an external activating signal is a beacon transmission from a site-specific BLE beacon device or an 802.11 beacon broadcasting a specific SSID, while a user-activity activating signal might occur when a user interacts with the device in some manner, or an alternative sensor detects that the device is moving (but the user has not authenticated to the device, or has attempted to authenticate and has failed). Unauthenticated broadcast messages are made in the blind. In the unauthenticated mode, the biometrically-authenticated wireless identification device operates according to a set of default operating characteristics corresponding to the device's current state as defined by at least one communications policy, for example as encoded in a default connectionless presence profile and default connectionless message content definitions. An example default operating characteristic might include transmitting a default signal in the blind that includes device-specific data such as a wireless identification device ID, a Bluetooth MAC address, and the wireless authentication device's current status. The transmission does not include user-specific information.

When a user successfully authenticates (e.g. becomes an authenticated user) to a device, the device (and its operating characteristics) is configured in accordance with the persona associated with the authenticated user.

### 6.2 Personas

A biometrically-authenticated wireless identification device as described herein is configured with one or more personas, each of which corresponds to one or more authenticated users of the device, or alternatively, to differing biometric indicia associated with a single user. A persona defines one or more configuration or operational settings (e.g. the communications policies) of the biometrically-authenticated wireless identification device associated with one or more authentication methods and the biometric indicia provisioned for one or more specific authenticated users. A plurality of personas is beneficial in situations when a device is shared by more than one user, when a single device may be used for a plurality of disparate (unrelated) access points that use differing authentication means or wireless protocols, such as when a user has access to a plurality of controlled spaces that are under the control of non-affiliated entities, or when differing information needs to be transmitted by the device about a user. In this case, each entity would separately provision portions of one or more persona(s). Each of the plurality of personas may correspond to a particular user's authenticating using a particular authentication method, such as fingerprint authenticating with a different finger (such as having a first persona associated with a first finger, and a second persona associated with a second finger), or by authenticating using differing authentication methods (e.g. such as a first authentication method being a fingerprint and a second authentication method being a voice print). For example, there may be differing persona details associated with the current authenticated user depending upon whether the user authenticated using a PIN/password or a biometric method. Similarly, a specific biometric indicia may be associated with a plurality of personas, or a plurality of biometric indicia may be associated with a single persona (e.g. either the left or right index fingers are used to authenticate).

### 6.3 Personalized Connectionless Message

A personalized connectionless message is defined herein as a message, comprising at least one data packet, transmitted by the biometrically-authenticated wireless identification device without the device first establishing either the presence of a listening device or having an established bidirectional communication connection with a recipient of the message. Exemplary connectionless messages include BT connectionless messages (such as BLE advertising packets, BT pairing messages, and BT device discovery messages) and other wireless signals such as RFID query messages broadcast by RFID-enabled devices, and WiFi Direct or WiFi Aware messages broadcast by WiFi-enabled devices. This behavior is called “transmitting in the blind”; the transmission itself is called a “blind transmission”. A personalized connectionless message includes one or more non-connectable data packets, i.e. data packets that do not elicit a request to establish a two-way connection from a recipient scanning device such as an access point. Personalized connectionless messages include information regarding, or related to, a particular biometrically-authenticated wireless identification device or a particular user of a biometrically-authenticated wireless identification device but, in contrast to connectable advertising and beacon packets used by Bluetooth and other TDMA networks and DSA radios, do not include information used to establish a network connection such as, for example, device configuration or capability information (e.g., generic attribute (GATT) service advertisement or node role), requested services (e.g., GATT service solicitation), and network configuration information (e.g., beacon frame interval, frame durations, or available frequencies).

A personalized connectionless message is a personalized informational transmission, transmitted in the blind, originating from the biometrically-authenticated wireless identification device. Examples of current “in the blind” transmissions include: a standard BLE advertising packet, a BLE advertising packet configured according to a specific Beacon protocol (e.g., configured according to an iBeacon protocol, an AltBeacon protocol, URIBeacon protocol, or an Eddystone protocol), a Bluetooth scan request or scan response packet, or a customized BLE advertising packet that does not necessarily conform to a known beacon format and that does not necessarily conform to the Bluetooth protocol A personalized connectionless message is characterized differently in that the in the blind transmission comprises one or more attributes that are associated specifically with the authenticated user of the device (and not just with the device itself) and can include multiple individual BLE 4 or BLE 5 data packets wherein each data packet includes a portion of the information contained in the personalized connectionless message.

In a first exemplary arrangement, a personalized connectionless message includes an advertising packet transmitted by a biometrically-authenticated wireless identification device and a scan response packet transmitted by the biometrically-authenticated wireless identification device following transmission of the advertising packet and subsequent to receipt of a scan request packet from an access point.

In a second exemplary embodiment, a personalized connectionless message includes a first, primary, advertising packet and one or more auxiliary advertising packets which are chained to the primary advertising packet.

In other exemplary embodiments, personalized connectionless messages may also include one-way transmissions communicated with non-Bluetooth communication methods such as RFID, NFC, MiFare, or any other suitable wireless communication.

A first aspect of the described biometrically-authenticated wireless identification device is that it transmits blind signals which are customized (e.g. personalized) in content based upon the current authenticated persona, e.g. the transmission comprises information unique to the currently authenticated persona. For example, the transmission for a first persona may include a first MAC address, and a distinct UUID or URL, and a transmission for a differing persona may include a second MAC, UUID, or URL address.

A second aspect of the described biometrically-authenticated wireless identification device is that it is configurable to automatically respond to pairing requests received by the biometrically-authenticated wireless identification device from specific pre-authorized Bluetooth devices based on the authenticated persona. The biometrically-authenticated wireless identification device may receive a pairing request from a Bluetooth device without first transmitting a connectable Bluetooth advertising packet that includes connection-related information such as access GATT capabilities advertisement or solicitation.

A third aspect of the described biometrically-authenticated wireless identification device is that it is configurable to share information, as customized content provided during a two-way communication session based upon the currently authenticated persona.

In an exemplary embodiment, a biometrically-authenticated wireless identification device provides, in response to a connectionless message information exchange, e.g., a Bluetooth-initiated information exchange, and as associated with a persona, a particular badge RFID, contact information of the authenticated user, a picture of the authenticated user, or aspects of a biometric template associated with the authenticated user. The biometric template includes information usable by a biometric identification system in order to confirm an authentication of the user.

### 6.4 Exemplary Embodiments

### 6.4.1 Exemplary Embodiment of a Biometrically-Authenticated Wireless Identification Card or Badge Holder Device

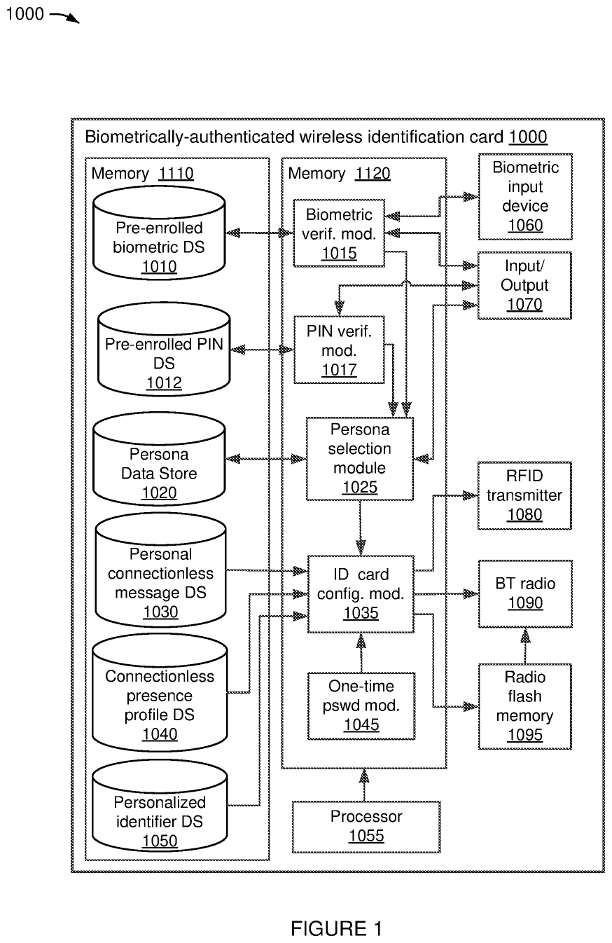

Referring to FIG. 1, an exemplary embodiment of a biometrically-authenticated wireless identification device comprising a biometrically-authenticated wireless identification card (1000) is shown in schematic view. In an alternative embodiment, a biometrically-authenticated wireless Fig device (not shown) is substantially similar to the biometrically-authenticated wireless identification card. A biometrically authenticated wireless identification card has a form factor similar to a standard identification or credit card. A biometrically authenticated wireless identification “fob” device has a form factor similar to a key fob or USB jump drive. The biometrically authenticated identification card and fob device include substantially similar components that are configured and that operate in a substantially similar manner. For clarity, the following description refers only to an identification card but is also applicable to a fob device as will be understood by those having ordinary skill in the art.

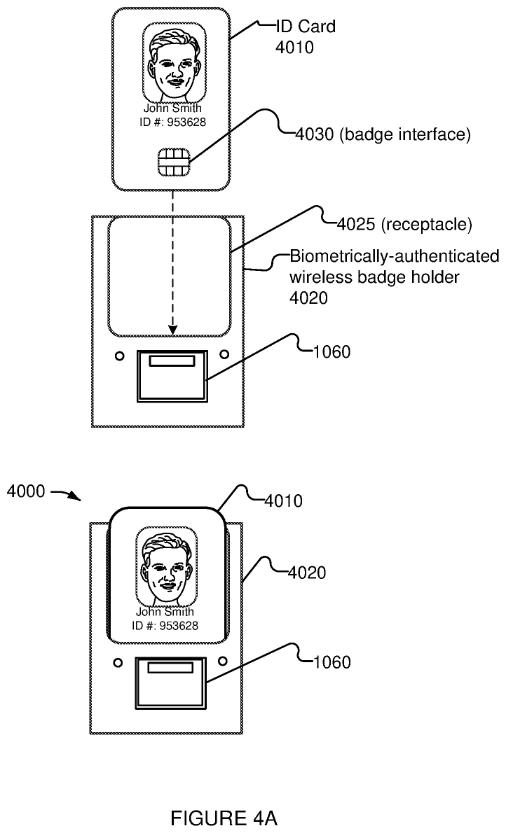

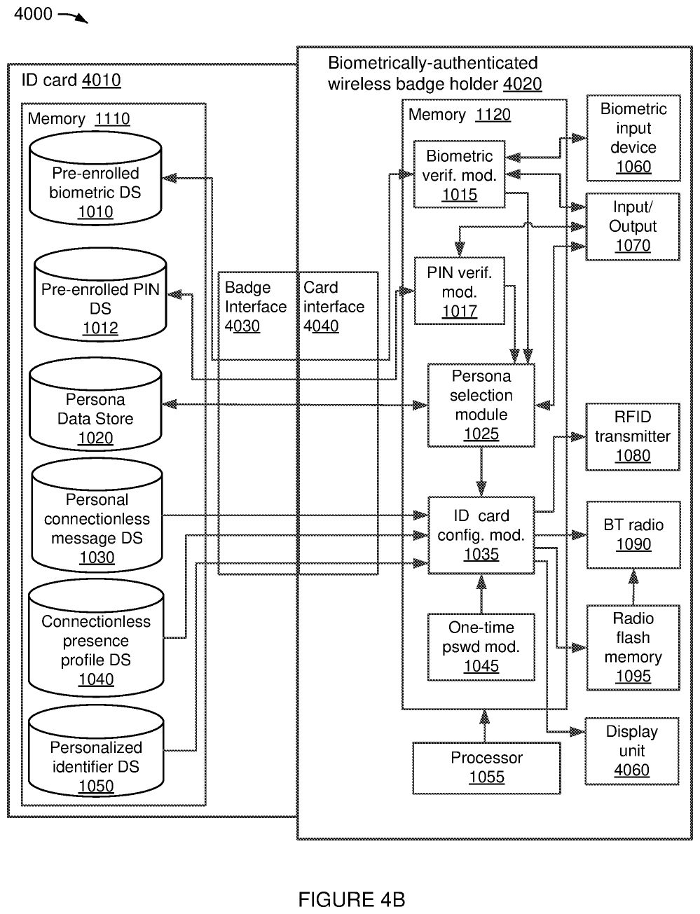

The biometrically-authenticated wireless identification card (1000) comprises at least one processor (1055), one or more persistent and transient memories (e.g. RAM and flash memory) (1095, 1110, 1120), an optional biometric input device such as a fingerprint scanner (1060), a wireless transceiver such as a Bluetooth radio (1090), and an RFID transmitter (1080). In a first exemplary embodiment, the biometrically-authenticated wireless identification card is a stand-alone access card. In a second exemplary embodiment, as illustrated in FIGS. 4A and 4B, the biometrically-authenticated wireless identification card is a badge holder dimensioned and configured to receive and hold a separate ID card that is configured to be inserted into the badge holder, where the badge holder pairs with the ID card and provides the biometric verification based upon information stored at least in part on the ID card. For example, in some implementations, as illustrated in FIG. 4B, components of the biometrically-authenticated wireless identification card are distributed between the badge holder and ID card, with the badge holder providing the active components and the ID card providing the passive memory components. This mechanism for component distribution enables the use of existing passive ID cards already in the field with the new features of the biometrically-authenticated wireless identification card, thereby avoiding the costs of reissuing IDs.

In a particular embodiment, the wireless transceiver is a Bluetooth Low Energy (BLE) radio. In other exemplary embodiments, the wireless transceiver is a wireless transceiver operating according to any suitable wireless protocol such as WiFi, NFC, ZWave, MiFare, or Zigbee.

The biometrically-authenticated wireless identification card also includes input/output (I/O) interfaces (1070) which provide interfaces to external biometric input devices such as a fixed iris scanner, microphone and voice print recognizer, external fingerprint scanner and non-biometric user input device such as a touchscreen, keyboard, and physical contact communication terminals. The I/O interfaces are used to receive user input from one or more external input devices to the identification card, and to provide control and data output to external devices.

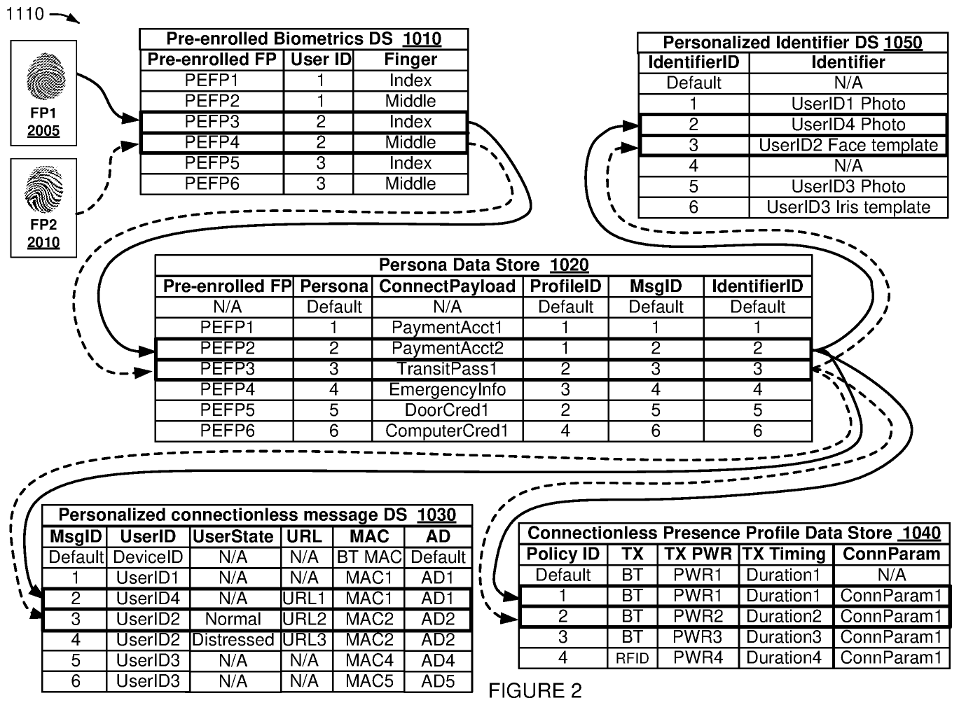

The persistent memory (1110) further comprises programs stored in memory. Specific programs may include a biometric verification module (1015), a persona selection module (1025), a one-time password module (1045), and an identification card configuration module (1035). When the biometrically-authenticated wireless identification card is in operation, the processor is configured to execute the programs stored in the memory. The persistent memory (1110) further comprises data stores, comprising: a pre-enrolled biometrics data store (1010), a persona data store (1020), a personalized connectionless message data store (1030), a personalized identifier data store (1050), and a connectionless presence profile data store (1040), as further illustrated in FIG. 2. In some exemplary embodiments, persistent memory (1110) and persistent memory (1120) comprise separate memories while in other exemplary embodiments persistent memory (1110) and persistent memory (1120) comprise a single, unitary, memory.

### 6.4.1.1 Data Stores

### 6.4.1.1.1 Persona Data Store (1020)

The persona data store (1020) comprises information about one or more personas. A default persona corresponds to an unauthenticated biometrically-authenticated wireless identification card or device. Each other, non-default, persona corresponds to at least one particular user authenticated using a specific way of authentication. For example, a persona corresponds to an enrolled user authenticated by a specific biometric indicia. In some embodiment, a persona may correspond to a plurality of specific biometric indicia that may be used to authenticate the user. Each persona comprises information, or mapping to information, that specifies one or more aspects of the configuration and operation of a biometrically authenticated wireless identification card. Referring to FIG. 2, an exemplary persona data store (1020) includes six personas, with 2 personas mapped to each of three users (as depicted in 1010). A different persona is associated with each of a user's two pre-enrolled fingerprints. In an alternative exemplary embodiment, a first persona is associated with multiple users and fingerprints.

Exemplary personas illustrated in (1020) of FIG. 2 include an identifier of personalized connectionless message data content (BeaconID), an identifier of a connectionless presence profile (ProfileID), an identifier of personalized identifier data content (IdentifierID) that is included in a personalized connectionless message or shared during a two-way communication session, for example with an access point, and information (ConnectPayload) that is shared by a biometrically-authenticated wireless identification card only during a two-way communication session. Each BeaconID corresponds to an entry in the personalized connectionless message data store (1030). Each ProfileID corresponds to an entry in the connectionless presence profile data store (1040). Each IdentifierID corresponds to an entry in the personalized identifier data store (1050). A persona may further comprise additional information, for example any biometrically-authenticated wireless identification card response to a pairing request (e.g. different authenticated users can have different pairings to various devices), and information shared by the biometrically-authenticated wireless identification card over a two-way Bluetooth communication session, for example a unique ID, serial number, facility code, payment account information, access token, transit pass, visitor pass information, a picture of an identification card user, vCard (VCF) contact information, access control credential information, emergency contact information, or medical history information.

### 6.4.1.1.2 Pre-Enrolled Biometrics Data Store (1010)

The pre-enrolled biometrics data store (1010) includes digital biometric indicia representing one or more pre-enrolled users, for example digital data representing a first fingerprint of an enrolled user (2005) and digital data representing a second fingerprint of the enrolled user (2010). Additional or alternative exemplary biometric indicia include one or more of a voice print, iris scan, photograph, or face template associated with the enrolled user.

A pre-enrolled biometrics data store entry is associated with one or more particular persona(s) via a pre-enrolled biometric indicia entry corresponding to one or more particular persona(s) in the persona data store (1020).

### 6.4.1.1.3 Personalized Connectionless Message Data Store (1030)

The personalized connectionless message data store (1030) includes pre-configured personalized connectionless message data content, or pre-configured personalized connectionless messages, each associated with one or more personas. A personalized connectionless message data store entry is associated with a particular persona via a BeaconID entry corresponding to the particular persona in the persona data store (1020).

Referring to FIG. 2, an exemplary Personalized Connectionless message data store includes one or more of: pre-configured advertising data (AD) for inclusion in a BLE advertising packet, a UserID, User State, URL, and MAC address, for each of six beacon IDs. Personalized connectionless message data content optionally includes additional or alterative personalized connectionless message data content (e.g., UUID, MAC address, URL, advertising data (AD)) corresponding to each pre-enrolled fingerprint.

### 6.4.1.1.4 Personalized Identifier Data Store (1050)

The personalized identifier data store (1050) includes pre-configured personalized identifier data content, each entry associated with one or more personas. A personalized identifier data store entry is associated with a particular persona via an IdentiferID entry corresponding to the particular persona in the persona data store (1020). Personalized identifier information includes information that the receiver uses to identify an authenticated user biometrically-authenticated wireless identification device. Collectively, this information is called biometric indicia. One example of this type of information is a biometric template. Alternative information types include pictures, voice print files, etc. Personalized identifier information includes, for example, a picture of the authenticated user or a pre-enrolled biometric template associated with the authenticated user.

### 6.4.1.1.5 Connectionless Presence Profile Data Store (1040)

The connectionless presence profile data store (1040) comprises one or more connectionless presence profiles, each further comprising operating specifications that define how a Bluetooth radio or RFID transmitter, or both, of the biometrically-authenticated wireless identification device is to be configured and operated. Exemplary operating specifications are include in table 1. A connectionless presence profile is associated with a particular persona via a ProfileID entry (see FIG. 2).

TABLE 1
Connectionless presence profile operating parameters

| Operating | |
|---|---|
| specification | Definition |
| Transmit format | Connectionless message transmission format |
| (TX) | (e.g., BT, RFID) |
| Transmission power | Transmission power setting of radio (e.g., BT or |
| (TX PWR) | RDFID radio) that broadcasts a connectionless |
| | message |
| Transmission duration | Length of time that connectionless message is |
| (TX Timing) | to be broadcast |
| Transmission interval | Time interval between repeated broadcasts of a |
| | connectionless message |
| Channels | One or more radio frequency channels or |
| | spectrum ranges that a connectionless message is |
| | broadcast on (e.g., one or more BT advertising |
| | channels) |
| Hopping pattern | Connectionless message transmission channel |
| | hopping pattern |
| Heartbeat period | An amount of time between checks by the |
| | biometrically-authenticated wireless identification |
| | card for a heartbeat message transmitted by a real |
| | time location services (RTLS) system |
| Deactivation event | An event or occurrence that causes the |
| | biometrically-authenticated wireless identification |
| | device to stop broadcasting a connectionless |
| | message (e.g., establishment of a one-to-one |
| | connection, receipt of stop message from a BT- |
| | enabled device, failure to detect heartbeat in |
| | RTLS system) |

The connectionless presence profile data store includes entries (ConnParam) that specify Bluetooth radio and RFID transceiver operating specifications used for establishing and maintaining a 2-way communication connection, for example for operating specifications for use during a Bluetooth pairing operation and subsequent communication session, for example Bluetooth PINs and additional Bluetooth security-related connection parameter data.

In further exemplary embodiments (not shown), the biometrically-authenticated wireless identification card includes one or more additional signal transmitters or transceivers, for example a WiFi transceiver or NFC transceiver, and the connectionless presence profile database includes entries that include configuration and/or operational information for the one or more additional signal transmitters or transceivers.

### 6.4.1.2 Program Modules

### 6.4.1.2.1 Biometric Verification Module (1015)

The biometric verification module (1015) receives, from the biometric input device (1060), biometric indicia such as a scanned biometric image (e.g., a fingerprint image or a digitized voice recording) or a biometric template generated by the biometric scanner based on scanned biometric information. The biometric verification module retrieves, from the pre-enrolled biometrics data store (1020), one or more pre-enrolled biometric indicia and attempts to determine a match between the just obtained biometric indicia and pre-enrolled biometric data in order to authenticate the user presenting the biometric indicia. If the biometric verification module determines the pre-enrolled and currently scanned biometric indicia match, it provides the IdentifierID(s) corresponding to the matched information to the persona selection module (1025).

### 6.4.1.2.2 Personal Identification Number (PIN) Verification Module (1017)

The personal identification number (PIN) verification module (1017) receives, from input/output device (1070), a string of characters, e.g., a string of one or more numbers and/or letters, entered by a user. The PIN verification module retrieves, from PIN data store (1022), one or more pre-enrolled PINs and attempts to determine a match between the just-obtained string of characters and pre-enrolled PINs in order to authenticate the user presenting the string of characters. If the biometric verification module determines a pre-enrolled PIN and the just entered string of characters match, it provides the IdentifierID(s) corresponding to the matched information to the persona selection module (1025).

### 6.4.1.2.3 Persona Selection Module (1025)

The persona selection module (1025) receives IdentifierID(s) as described above. The persona selection module selects, from the persona date store (1020), one or more persona identifier(s) corresponding to the received IdentifierID. The persona selection module retrieves reference information corresponding to the selected persona identifier(s) from the persona data store. The reference information includes sets of ConnectPayload, ProfileID, and BeaconID, corresponding to the received IdentifierID(s) and associated persona. The persona selection module provides the selected information to the identification card configuration module (1035). In an alternative embodiment, the persona selection module retrieves, and provides to the identification card configuration module, the selected persona identifier(s) and the identification card configuration module retrieves the reference information corresponding to the selected persona identifier(s) from the persona data store.

### 6.4.1.2.4 Identification Card Configuration Module (1035)

The identification card configuration module (1035) receives, from the persona selection module, or retrieves, from the persona data store, the above referenced information corresponding to the selected persona identifier(s). The identification card configuration module configures the biometrically-authenticated wireless identification card based on the reference information.

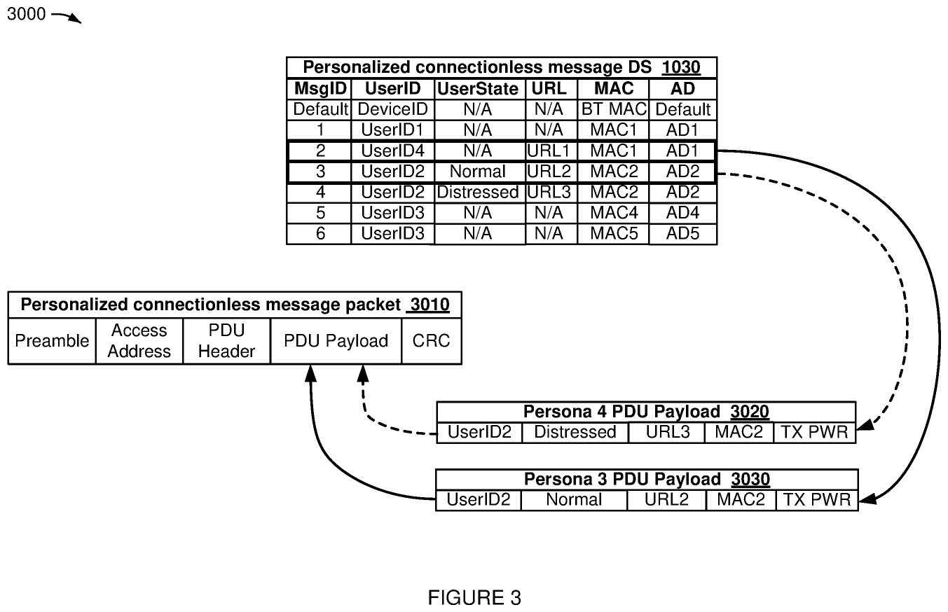

Referring to FIG. 3, the identification card configuration module (1035) retrieves, from the personalized connectionless message data store (1030), personalized connectionless message content, e.g., one or more of a UserID, User State, URL, and MAC address, constructs a PDU payload (e.g., 3020, 3030) that includes the retrieved personalized connectionless message content, and creates a personalized connectionless message packet (3010) that includes the PDU payload. In an alternative exemplary embodiment, the personalized connectionless message data store (1030) includes one or more pre-configured personalized connectionless message packets (not shown), each packet corresponding to a specific persona, and the identification card configuration module retrieves, from the personalized connectionless message data store, a pre-configured beacon personalized connectionless message packet corresponding to the selected persona identifier. The identification card configuration module loads the personalized signal packet into the radio flash memory (1095).

In an exemplary embodiment, the identification card configuration module (1035) receives, from the optional one-time password module (1045), a time-sensitive verification indicia, such as a single-use password, and includes the time-sensitive verification indicia in a personalized connectionless message packet (3010) as an anti-spoofing measure.

The identification card configuration module (1035) retrieves, from the connectionless presence policy data store, one or more operating policy(ies) corresponding to a selected persona identifier. The identification card configuration module configures one or more of the Bluetooth radio (1090), RFID transmitter (1080), and additional radio transceivers (not shown) according to the retrieved connectionless presence policy.

### 6.4.1.2.5 One-Time Password Module (1045)

In an optional embodiment, the one-time password module (1045) generates a time-sensitive verification indicia, such as a single-use password, which the biometrically-authenticated wireless identification card includes in a personalized connectionless message data packet as an anti-spoofing measure. The one-time password module provides the time-sensitive verification indicia to the identification card configuration module.

### 6.4.2 Exemplary Embodiment of a Biometrically-Authenticated Wireless Identification MBX Badge Holder and Identity Card

Referring to FIGS. 4A and 4B, an embodiment of a biometrically authenticated wireless identification badge holder (4020) and identity card (4010) are illustrated in general and schematic views. The badge holder includes an identification card receptacle (4025) for receiving and mechanically interfacing with the identification card. The wireless identification card includes a badge interface (4030) that interfaces with a corresponding identification card interface component (4040) of the badge holder. The identification card interface is disposed in the interior of the identification card receptacle.

In an exemplary embodiment, the badge interface and identification card interface comprise a contact-based interface including physical connectors and utilizing communication protocols complying with contact smart card interface standards, for example with the ISO/IEC 7810 and ISO/IEC 7816 series of standards. In another exemplary embodiment, the badge interface and identification card interface comprise a contactless smart card interface such an RF connection interface wherein the ID card is powered by the badge holder via RF induction. In this embodiment, the card interface of the badge holder includes an RF transmitter and the badge interface of the ID card includes an inductor to capture and rectify RF signals from the badge holder to power the ID card's electronics.

When the identification card is mounted in the identification card receptacle, the identification card and badge holder are communicatively coupled via the badge interface and the card interface component. The communicatively coupled identification card and badge holder (4000) include substantially the same components as the biometrically authenticated wireless identification card illustrated in FIG. 2 and the components of coupled identification card and badge holder perform substantially the same functions and processes described in relation to FIGS. 1, 2, and 3.

The biometrically-authenticated wireless identification badge holder includes a card interface (4040) for interfacing with an identification card (4010). The biometrically-authenticated wireless identification badge holder includes a processor (1055), one or more badge holder persistent and transient memories (e.g. RAM and flash memory) (1095, 1120), a biometric input device such as a fingerprint scanner (1060), a wireless transceiver such as a Bluetooth radio (1090), and an RFID transmitter/receiver (1080).

The biometrically-authenticated wireless identification badge holder includes input/output (I/O) interfaces (1070) which include a card interface (4040) that includes physical contact communication terminals and which includes a user input device such as a touchscreen or keyboard. The I/O interfaces may be used to communicate data to and from an identification card, receive user input, input from one or more external devices, to the identification card, devices or components, and to provide biometrically-authenticated wireless identification badge holder output to one or more devices or components.

The biometrically-authenticated wireless identification badge holder a display unit (4060) that is configurable by the identification card configuration module (1035). In an exemplary embodiment the display unit includes one or more color emitting display devices, for example a green LED and a red LED.

The badge holder persistent memory (1120) includes programs stored in memory. The programs include a biometric verification module (1015), PIN verification module (1017), a persona selection module (1025), a one-time password module (1045), and an identification card configuration module (1035). When the biometrically-authenticated wireless identification card is in operation, the processor is configured to execute the programs stored in the memory.

The identification card includes a badge interface (4030) for interfacing with a biometrically-authenticated wireless identification badge holder (4020). The identification card includes one or more identification card persistent and transient memories (e.g. RAM and flash memory) (1110). The identification card persistent memory also includes a pre-enrolled biometrics data store (1010), a pre-enrolled PIN data store (1012), a persona data store (1020), a personalized connectionless message data store (1030), a personalized identifier data store (1050), and a connectionless presence profile data store (1040).

As depicted in FIG. 2, when a user authenticates to the biometric scanner of the badge holder, the biometric verification module accesses, via the card interface and badge interface, pre-enrolled biometric data stored in the pre-enrolled biometrics data store on the identification card. Similarly, the badge holder persona selection module accesses one or more personas stored in the persona data store on the identification card. The badge holder identification module access data stored on the identification card including data stored in the personal connectionless message data store, the connectionless presence profile data store, and the personalized identifier data store.

Storing personalized data such as pre-enrolled biometric data, pre-enrolled PIN data, and persona-related data on a separate identification card is advantageous in that multiple users can use the biometrically authenticated wireless badge holder and that the biometrically authenticated wireless badge holder does not need to be provisioned with information corresponding to the multiple users. Personalized data of a particular user is maintained securely on an associated identification card and is not stored permanently on the biometrically authenticated wireless badge holder, thereby increasing privacy and security of the personalized data.

### 6.5 Exemplary Embodiment of a Biometrically-Authenticated Wireless Identification Mobile Electronic Device

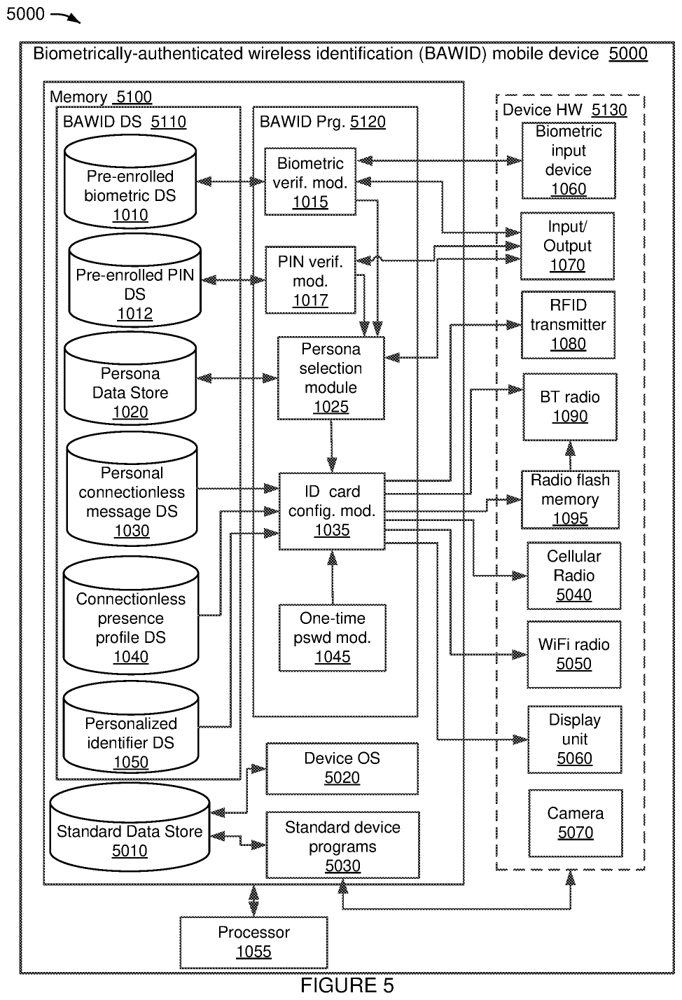

Referring to FIG. 5, an exemplary biometrically-authenticated wireless identification mobile device (5000) is shown in schematic view. The biometrically-authenticated wireless identification mobile device is a mobile electronic device such as a mobile phone, electronic tablet, personal digital assistant, or the like. The biometrically-authenticated wireless identification mobile device includes a processor (1055) and device memory (5100) which includes specialized software (5120) and data stores (5110) that include biometrically-authenticated wireless identification (BWAID) mobile device programs. The specialized BAWID programs include: biometric verification module (1015), PIN verification module (1017), persona selection module (1025), identification device configuration module (1035), and one-time password module (1045). The specialized BAWID data stores include: pre-enrolled biometric data store (1010), pre-enrolled PIN data store (1012), persona data store (1020), personal beacon data store (1030), connectionless presence data store (1040), and personalized data store (1050).

The biometrically-authenticated wireless identification mobile device further includes a device operating system (OS) (5020) and standard device programs (5030) which can include, for example, one or more applications (Apps), internet browser, access control software, and VPN software. The memory includes a standard data store (5010) which includes data stores that can store data usable by the device OS and standard programs.

The biometrically-authenticated wireless identification mobile device includes device hardware components (5130) common to the previously biometrically-authenticated wireless identification card including a biometric input device (1060), I/O interface (1070), RFID transmitter (1080), Bluetooth radio (1090), and flash memory (1095). The biometrically-authenticated wireless identification device further includes a cellular radio (5040) operable for communication on a cellular communication network, a WiFi radio (5050) operable for communication with a WiFi network, and a display unit (5060) such as an LED screen operable to display text and images. In some embodiments, the display unit can be an I/O display, such as a capacitive touch screen and as such can be used in addition to, or in place of, the I/O interface. In some embodiments, the biometrically-authenticated wireless identification device includes a camera (5070). Some embodiments of the biometrically-authenticated wireless identification mobile device do not include one or more of Bluetooth radio, RFID transmitter, cellular radio, and WiFi radio.

The specialized BAWID programs are operable by the processor to perform personalized beaconing functions and other functions previously described in relation to the biometrically-authenticated wireless identification card illustrated in FIG. 1 and in relation to FIGS. 2 and 3. The BAWID data stores can be provisioned with data such as pre-enrolled biometrics and persona-related information in a manner substantially similar to that described in relation to the biometrically-authenticated wireless identification card.

The biometrically-authenticated wireless identification mobile device is configurable to operate according to one or more personas selectable by a manner in which a user authenticates to the biometric scanner. The biometrically-authenticated wireless identification mobile device is operable to transmit personalized connectionless messages, receive and respond to Bluetooth connectionless messages, and interact with Bluetooth-enabled and RFID-enabled access points as described in relation to the biometrically-authenticated wireless identification card. Generally, the biometrically-authenticated wireless identification mobile device performs functions described in relation to the biometrically-authenticated wireless identification card.

A first additional function performed by a biometrically-authenticated wireless identification mobile device includes transmitting personalized connectionless messages using the WiFi radio and communicating with an access control device over a WiFi network connection. The biometrically-authenticated wireless identification mobile device transmits non-connectable WiFi connectionless messages that include personalized connectionless message data payloads described previously.

A second additional function performed by the biometrically-authenticated wireless identification mobile device includes establishing a one-to-one WiFi communication session with a WiFi enabled device, e.g. a WiFi-enabled access point, and communicating information specific to a selected persona over the one-to-one WiFi communication session. The biometrically-authenticated wireless identification mobile device transmits personalized connectionless messages, e.g. BLE or WiFi formatted signals, prior to establishing a WiFi connection with a WiFi-enabled access point.

In an embodiment, the biometrically-authenticated wireless identification mobile device establishes a WiFi connection with the access point in response to receiving a message from the access point in a Bluetooth beacon or other network protocol communication packet and communicates information corresponding to a selected persona over the WiFi connection. A biometrically-authenticated wireless identification mobile device persona includes configuration settings for the WiFi radio. A connectionless presence profile, stored in the connectionless presence data store, includes operational settings for the WiFi radio. When a particular persona is active, the identification device configuration module configures the WiFi radio to operate according to a connectionless presence profile associated with the particular persona. In an exemplary embodiment, the identification device configuration module configures the WiFi radio to establish a WiFi connection with a WiFi-enabled access point and to transmit data contained in a ConnectPayload entry, from the Persona Data Store, associated with an active persona.

A third additional function performed by the biometrically-authenticated wireless identification mobile device includes displaying persona-specific information on the display unit. The identification device configuration module can configure the display unit to display information associated with a selected persona such as a transit pass ID code, electronic ticket information, or a scannable bar code or QR-code. The display unit can be configured to display a solid color (e.g., green or red) or a color pattern. In some embodiments, the identification device configuration module configures the display unit in response to the biometrically-authenticated wireless identification mobile device's receiving a data packet from an access control point. In an exemplary embodiment, the biometrically-authenticated wireless identification device receives a data packet confirming authentication or approval of the device or a payment or transit pass account associated with a selected persona and, in response, the color green is shown on the display unit.

### 6.6 Exemplary Enrollment Process

An enrollment process is used to provision a biometrically-authenticated wireless identification card with information that is included in the pre-enrolled biometric data store, persona data store, personal beacon data store, and connectionless presence data store. An exemplary enrollment process includes connecting a biometrically-authenticated wireless identification card via a physical input/output interface with an enrollment system, although any supported communications mechanism may be utilized. The enrollment system is configured to enable an authorized administrator to transfer data into, remove data from, or change data within the data stores.

An authorized administrator generates pre-configured personalized connectionless messages, associates each pre-configured personalized connectionless message with a particular persona, and loads materials required to generate the pre-configured personalized connectionless messages into the personalized connectionless message data store.

An authorized administrator populates the pre-enrolled biometrics data store with pre-enrolled biometric data, populates the personalized connectionless message data store with personalized connectionless message data content (or pre-configured personalized connectionless messages), and populates the connectionless presence profile data store with preconfigured connectionless presence profile operating parameters. Exemplary connectionless presence profile operating parameters are listed in Table 1.

The authorized administrator generates pre-configured personalized identifiers, creates one or more personas, associates pre-enrolled biometric(s) and personalized identifiers with each persona, and loads the personas into the persona data store.

Referring to FIG. 2, in an exemplary embodiment a biometrically authenticated wireless identification card is connected to an authentication system via input/output interface (1070) using a contact connection method, for example a method that is in compliance with the ISO/IEC 7810 and/or ISO/IEC 7816 series of standards, or a contactless connection method, for example via a one-to-one BT connection. An authorized administrator populates the pre-enrolled biometrics data store with pre-enrolled fingerprint biometric data corresponding to the middle and index fingers of each of three users. In other exemplary embodiments, the authorized administrator populates the pre-enrolled biometrics data store with pre-enrolled fingerprint data for more or fewer than three users, and more or fewer than two fingers for each user. In another example, the authorized administrator configures the pre-enrolled biometrics data store with one or more additional or alternative pre-enrolled biometrics indicia (e.g., voice print data) corresponding to a user.

### 6.7 Exemplary Operating Mode

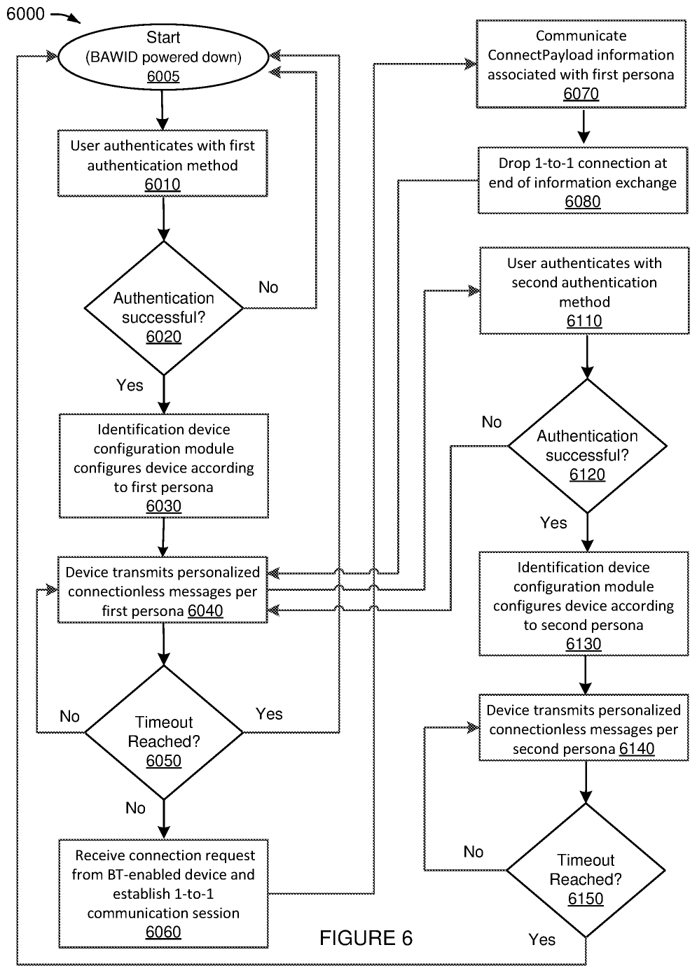

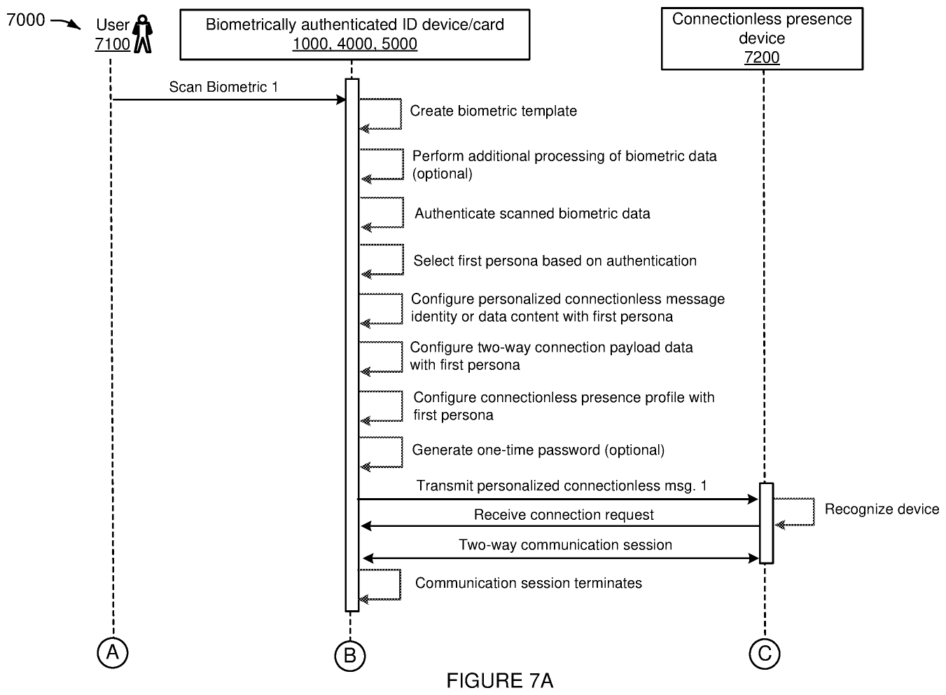

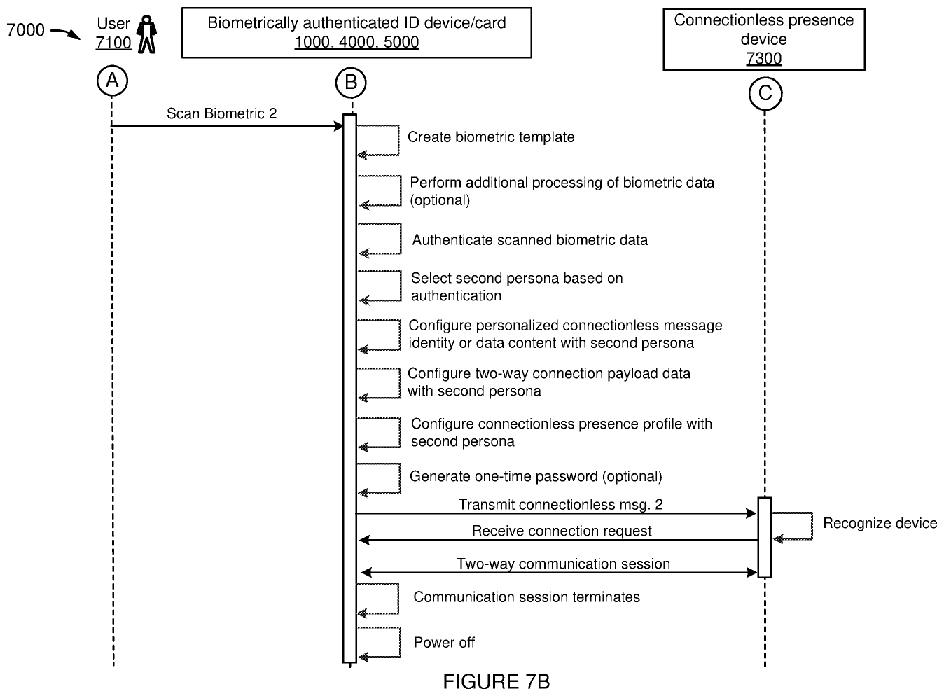

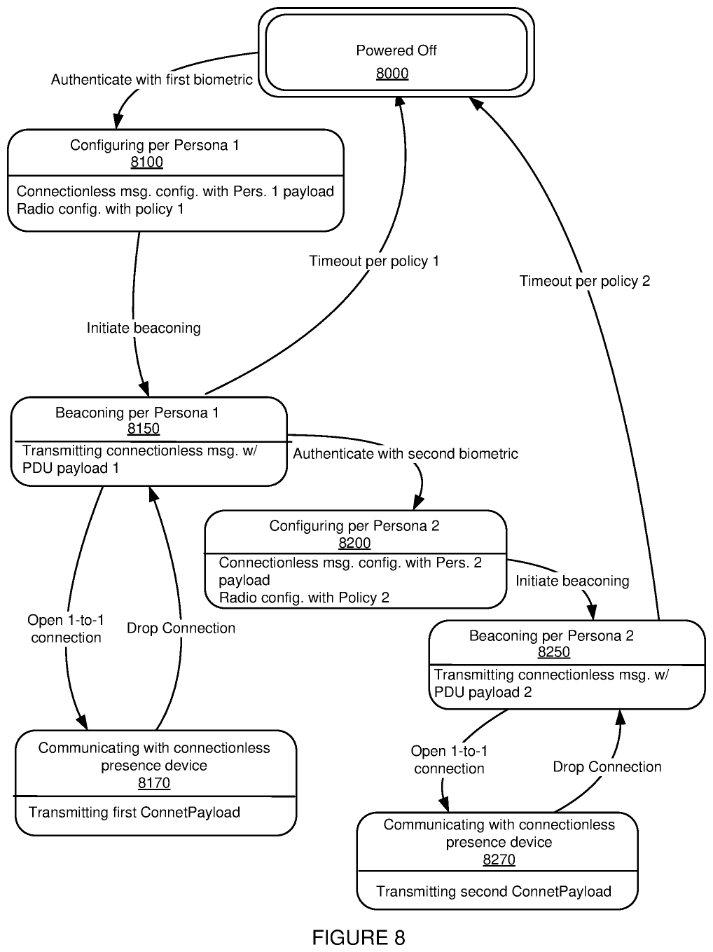

An exemplary operating mode of a biometrically authenticated wireless identification card is described in relation to FIGS. 2, 4, 6, 7, and 8. FIG. 6 is an exemplary process flow chart, FIGS. 7A and 7B depict exemplary information flows, and FIG. 8 depicts an exemplary state diagram of an exemplary operating mode of a biometrically-authenticated wireless identification device according to an embodiment of the invention. The exemplary operating mode is also applicable to a biometrically authenticated wireless Fig, a biometrically authenticated wireless MBX badge holder, and a biometrically authenticated mobile wireless device.

In step (6005) of an example operating mode for the biometrically-authenticated wireless identification card, the biometrically-authenticated wireless identification device starts in a powered off state (8000). In an alternative embodiment, a biometrically-authenticated wireless identification card operates in a default state prior to a user authenticating to the card. Referring to FIG. 2, a biometrically-authenticated wireless identification card loads a default persona, which is associated with default connectionless presence profile operating parameters and default connectionless message content, for example an identifier of the biometrically-authenticated wireless identification card and a MAC address corresponding to the card's BT radio. The biometrically-authenticated wireless identification card can begin transmitting default connectionless messages upon receiving a connectionless message such as a BT beacon signal from a separate connectionless messages generating device such as a base station, access control point, or BT beacon device. In a further embodiment, a In a further embodiment, a connectionless presence device includes a location module (not shown) such as a GPS module or WiFi geolocation module and is configured to begin generating connectionless messages based on a device location determined by the location module.

In step (6010), the user (7100) initiates an authentication attempt with a first authentication method, and the biometrically-authenticated wireless identification device powers on. In an exemplary embodiment, the user scans a first finger on the biometric input device (1060). The biometric scanner optionally includes a biometric template creation algorithm that creates a biometric template (e.g., 2005) corresponding to the scanned finger by encoding, as digital fingerprint scan data, an image of the scanned fingerprint or biometric indicia generated by the algorithm from an image of the scanned fingerprint. The biometric scanner, or a separate biometrics processing module (not shown for clarity) can perform additional processing of the digital fingerprint scan data to generate additional scanned biometric indicia; for example, to extract a simplified representation of whorl patterns and intersection points. In another exemplary embodiment the input/output interface (1070) includes a microphone and audio-to-digital translation component and the biometric verification module (1015) comprises a voice print recognition module. A user provides an audio sample to the input/output interface which digitizes the audio sample and provides the digitized audio sample to the biometrics verification module. The biometrics verification module retrieves one or more pre-enrolled voice print indicia or templates from the pre-enrolled biometrics data store (1010) and attempts to authenticate the user based on the provided audio sample.

In step (6020), a biometric verification module program (1015) receives the digital fingerprint scan data (or other scanned biometric indicia), and attempts to authenticate it by comparing it to pre-enrolled biometric data from the pre-enrolled biometrics data store (1010). If a match is found and authentication is successful, the biometric verification module provides an identifier of the matching pre-enrolled biometric data to the persona selection module (1025). The persona selection module retrieves, from the persona data store (1020), a persona that corresponds to the pre-enrolled biometric data identity. In an exemplary operating mode, in FIG. 2, the biometric verification module program determines that the scanned fingerprint (e.g. FP1/2005) corresponds to a pre-enrolled fingerprint (e.g. PEFP3) in the pre-enrolled biometric data store (1010), and provides this identifier to the persona selection module, which determines that the pre-enrolled fingerprint identifier corresponds to a persona (e.g. Persona 3) in the persona data store (1020). If authentication is not successful, the biometric verification module program terminates, and the biometrically-authenticated wireless identification device re-enters a powered off state (8000).

The biometrically-authenticated wireless identification card can make one or more alternative or backup authentication means available to a user. An exemplary biometrically-authenticated wireless identification card includes primary and secondary, or backup, pre-enrolled biometric data If the user is unable to authenticate to the biometrically-authenticated wireless identification card using a first primary finger, for example if the user has injured their first primary finger, the user attempts to authenticate using a first backup finger. If the user successfully authenticates using the first backup finger, the persona selection module retrieves a persona corresponding to the first finger from the persona data store and provides the persona to the identification card configuration module.

An additional exemplary biometrically-authenticated wireless identification card has an I/O interface (1070) that includes a touchscreen or keyboard that a user can user to enter authentication information such as a PIN. The additional exemplary biometrically-authenticated wireless identification card includes, in the persona data store, personas indexed by authentication information and by pre-enrolled biometrics identifier. If a user fails to authenticate to a biometrically-authenticated wireless identification card biometrics scanner, the user can enter authentication information using the I/O interface. The I/O interface provides the authentication information to the PIN verification module (1017). The PIN verification module retrieves pre-enrolled PIN information from the pre-enrolled PIN data store (1012) and attempts to authenticate the user based on the authentication data. If the PIN verification module is able to authenticate the user, it provides a personaID corresponding to the authenticated user to the persona selection module. The persona selection module then retrieves a persona corresponding to the authentication information from the persona data store and provides the retrieved persona to the identification card configuration module.

In a further exemplary embodiment, an external biometrics device can be used as a backup if a user is unable to authenticate to a biometrically-authenticated wireless identification card using the card's biometric scanner. A biometrically-authenticated wireless identification card communicates, via the I/O interface, with an external biometric authentication system such as an external biometrics scanner device.

In an exemplary embodiment, if a user is unable to authenticate with a biometrically-authenticated wireless identification card using the card's biometric scanner, the user connects the identification card I/O interface to an external biometrics device. An external biometric authentication device can be used to authenticate a user to a biometrically-authenticated wireless identification card. The external biometrics device prompts the user to provide biometric data to the external biometrics device, for example by sliding a finger over a fingerprint reader of the external biometrics device or looking into an iris scanner of the external biometrics device. The external biometrics device collects, digitizes, and (optionally) further processes, scan data to generate externally generated biometric indicia. The external biometrics device communicates the externally generated biometric indicia to the biometrically-authenticated wireless identification card via the identification card I/O interface. The I/O interface passes the externally generated biometric indicia data to the biometric verification module.

In step (6030) an identification card configuration module (1035) configures the device according to the first persona, as authenticated in step (6020), while in a device configuration state (8100). The identification card configuration module receives the first persona from the persona selection module (1025) and uses the information included in the first persona to configure the Bluetooth (1090) and/or RFID (1080) transceiver for operation. In an exemplary operating mode, in FIG. 2, the identification card configuration module extracts, from the first persona (e.g. Persona 3), an identifier of a connectionless presence profile (e.g., ProfileID2), an identity of personalized connectionless message or personalized connectionless message data content (e.g., BeaconID3), and two-way connection payload data (e.g., TransitPass1) that is included in one or more data messages exchanged between the biometrically-authenticated wireless identification card and an access point during a two-way communication session. The identification card configuration module then extracts the configuration information for ProfileID and BeaconID from one or more additional data stores, for example personalized connectionless message data store (1030) and connectionless presence data store (1040).

The identification card configuration module constructs a personalized connectionless message by retrieving, from the personalized connectionless message data store, personalized connectionless message data, and loading the personalized connectionless message data in a personalized connectionless message packet. For example, referring to FIG. 3, the identification card configuration module retrieves, from the personalized connectionless message data store (1030), BeaconID3 personal connectionless message data including UserID2, User State=“Normal”, URL2, and MAC2, generates personalized connectionless message packet P3 PDU payload (3030), and loads the personalized connectionless message packet Persona 3 PDU payload into a personalized connectionless message packet (3010). In an alternative embodiment, the identification card configuration module retrieves, from personalized connectionless message data store, a personalized connectionless message packet, preconfigured with personalized connectionless message data corresponding to the persona.

The identification card configuration module can add time-sensitive data, such as a one-time password, to the personalized connectionless message. The time-sensitive data can be used by an access point module as a spoofing counter measure. The one-time password module (1045) generates a one-time password, which the identification card configuration module retrieves and adds to the personalized connectionless message. The identification card configuration module loads the personalized connectionless message into flash memory (1095) of the Bluetooth radio (1090).

In an exemplary arrangement, the identification card configuration module retrieves, from the connectionless presence profile data store (1040), a connectionless presence profile that includes Bluetooth radio and/or RFID operating instructions and configures the Bluetooth radio and/or RFID transceiver to operate in accordance with the connectionless presence profile. The identification card configuration module retrieves, from the connectionless presence profile data store, a connectionless presence profile specified by the persona, for example, referring to FIG. 2, connectionless presence profile (ProfileID2). The identification card configuration module parses the retrieved connectionless presence profile to determine settings for one or more Bluetooth radio and RFID transceiver configuration and operating specifications. For example, the identification card configuration module parses ProfileID2 and, based on a TX entry of ProfileID2, determines that the Bluetooth radio is to be activated in order to transmit a personalized connectionless message stored in radio flash memory at a transmit power (PWR1) specified by a TX PWR entry of ProfileID2.

The identification card configuration module examines the TX Timing entry of ProfileID2, and determines that the Bluetooth radio transmits the personalized connectionless message for Duration2. For example, the identification card configuration module configures the Bluetooth radio, according to the connectionless presence profile, to transmit the personalized connectionless message periodically, for example, every 10 seconds, every second, or every 250 ms, and configures the Bluetooth radio with a timeout setting that causes the biometrically-authenticated wireless identification card to stop transmitting the personalized connectionless message after a specified amount of time, for example 30 minutes.

The identification card configuration module configures the Bluetooth radio, according to the connectionless presence profile, to stop transmitting a personalized connectionless message when a personalized connectionless message transmission stop event occurs. For example, the identification card configuration module configures the Bluetooth radio to continue transmitting personalized connectionless messages until a Bluetooth-enabled access control point instructs the biometrically-authenticated wireless identification card to stop transmitting personalized connectionless messages, to stop transmitting personalized connectionless messages if the biometrically-authenticated wireless identification card does not receive a heartbeat transmission, or until a user scans a same or different finger or otherwise interacts with the biometrically-authenticated wireless identification card cause the identification card to stop transmission of personalized connectionless messages.

In an RTLS use case, the biometrically-authenticated wireless identification card transmits personalized connectionless messages for period of time (4 or 6 hours) specified by a connectionless presence profile corresponding to an active persona. The biometrically-authenticated wireless identification card checks for a heartbeat signal transmitted by the RTLS system with a periodicity specified in persona data, for example every 10 seconds. If the user of the biometrically-authenticated wireless identification card moves out of range of the RTLS network, the identification card powers off. The identification card is configured, according to an active persona, to stop transmitting personalized connectionless messages and to power down if the identification card does not detect a heartbeat signal during a configurable number of heartbeat checks. In an exemplary use case, a medical care worker in a hospital with an RTLS system authenticates to a biometrically-authenticated wireless identification card at the beginning of a shift. The biometrically-authenticated wireless identification card continues to transmit personalized connectionless messages as long as the identification card is able to detect a heartbeat signal transmitted by the RTLS system. When the medical care worker leaves the hospital after completing the shift, the biometrically-authenticated wireless identification card fails to detect a heartbeat signal and powers down.

In step (6040), the biometrically-authenticated wireless identification card enters a personalized beacon transmission state (8150) wherein it transmits the personalized connectionless message packet constructed with information corresponding to the first persona using transmission power level and transmission interval parameters specified by the connectionless presence policy associated with the first persona. The biometrically-authenticated wireless identification card transmits personalized connectionless messages during three distinct periods: first, when the card is powered on following successful authentication by a user and prior to establishing a one-to-one Bluetooth connection with a compatible Bluetooth-enabled device; second, when the biometrically-authenticated wireless identification card receives a return signal from another device; and third, when the biometrically-authenticated wireless identification card enters a low power mode and continues to transmit connectionless messages after a one-to-one Bluetooth connection with a compatible Bluetooth-enabled device has been established and subsequently torn down. The biometrically-authenticated wireless identification card transmits personalized connectionless messages corresponding to the same persona during each of the three periods or, alternatively, transmits personalized connectionless message corresponding to a different persona during at least one of the periods.

In step (6050), if a timeout period (pre-set by policy) is exceeded without establishing a two-way communication session, the transmission terminates, and the biometrically-authenticated wireless identification device powers off and re-enters a powered off state (8000). If the timeout period has not been reached, the biometrically-authenticated wireless identification card continues to transmit the personalized connectionless message packet.

In step (6060), the biometrically-authenticated wireless identification card receives a connection request from a Bluetooth-enabled device (7200) in response to the personalized beacon, and establishes a two way connection with the Bluetooth-enabled device.

The identification card configuration module configures the Bluetooth radio or RFID transceiver for a two-way communication session based on information included in a ConnParam entry in a connectionless presence profile and a ConnectPayload entry in a persona. For example, referring to FIG. 2, when a user has authenticated with the biometrically-authenticated wireless identification card using a finger that corresponds to Persona 3, the identification card configuration module configures the identification card to communicate TransitPass1 information to a Bluetooth-enabled access point, for example with a transit system access point, when the biometrically-authenticated wireless identification card and the access point are engaged in a two-way communication session. In addition, the identification card uses information parsed from ConnParam1 entry of connectionless presence ProfileID2, such as a PIN, hash of a Bluetooth PIN, or pre-negotiated pairing materials, when negotiating a pairing operation with an access point or other Bluetooth device.

In step (6070), the biometrically-authenticated wireless identification card communicates its ConnectPayload information associated with the first persona to the Bluetooth-enabled device while in a two-way communication state (8170).

In step (6080), upon completion of the information exchange, either the biometrically-authenticated wireless identification card or the Bluetooth-enabled device drops the two-way communication connection. At this point, the biometrically-authenticated wireless identification card can return to the beaconing state (8150) of step (6040) if the card has another personalized connectionless message packet for the first persona, or the card can be configured for a second persona.

The procedure for authenticating and using a second persona follows the same steps as for the first persona. In step (6110), the user (7100) authenticates with a second authentication method. If the authentication is successful in step (6120), in step (6130), the identification device configuration module configures the biometrically-authenticated wireless identification card according to the second persona while in a configuration state (8200). In step (6140), the biometrically-authenticated wireless identification card enters a beaconing state (8250) wherein it transmits personalized beacons according to the second persona until it reaches timeout (step 6150) and re-enters a powered off state (8000) or establishes a two-way connection with a Bluetooth-enabled device (7300), enters a two-way communication state (8270), and communicates its ConnectPayload information associated with the second persona to the Bluetooth-enabled device. Upon completion of the information exchange, either the biometrically-authenticated wireless identification card or the Bluetooth-enabled device drops the two-way connection.

In an exemplary operating mode, when a user authenticates to the biometrically-authenticated wireless identification card by scanning a first finger on the fingerprint scanner, the persona selection module retrieves a first persona from the persona data store (1020). When the user authenticates to the biometrically-authenticated wireless identification card using a second finger, the persona selection module retrieves a second persona from the persona data store. The first and second personas includes differing configuration settings for the biometrically-authenticated wireless identification card such as different personalized connectionless message content and different content shared, by the card, over a two-way communication session.

In an exemplary authentication sequence, a user authenticates with a first finger to select a first persona, e.g. Persona 3. The biometrically-authenticated wireless identification card powers on and begins transmitting a personalized connectionless messages as specified by the selected persona, for example personalized connectionless messages that include a normal UserState. The user authenticates to the powered-on biometrically-authenticated wireless identification card using a second finger to cause the biometrically-authenticated wireless identification card to load a second persona, e.g. Persona 4. In a particular embodiment, selection of the second persona requires prior selection of the first persona and must occur within a configurable amount of time following selection of the first persona. When the second persona is loaded, the biometrically-authenticated wireless identification card stops transmitting personalized connectionless messages specified by the first persona and begins transmitting personalized connectionless messages specified by the second persona, for example connectionless messages with a distressed UserState. Requiring a two-step authentication to cause the second persona to be selected provides a safeguard against accidentally selecting a particular persona and causing the biometrically-authenticated wireless identification card to perform a particular action such as transmitting a distress signal.

### 6.8 Personalized Connectionless Message Including User Status

Referring to FIGS. 2 and 3, exemplary personalized connectionless message content loaded on a biometrically-authenticated wireless identification card includes an indication of a status of a user. User 2's index finger is associated with a persona (Persona 3) that includes ConnectPayload (TransitPass1) and that references personalized connectionless message content (BeaconID3) that includes status=“normal”. User 2's middle finger is associated with a persona (Persona 4) that includes ConnectPayload (EmergencyInfo) and that references to personalized connectionless message content (BeaconID4) that includes status=“distressed”.

In an exemplary operating mode, User 2 authenticates to the biometrically-authenticated wireless identification card with their index finger. The identification card configuration module configures the biometrically-authenticated wireless identification card to transmit a personalized connectionless message with a PDU payload (3030) that includes status=“normal” using Bluetooth radio operating specifications specified by connectionless presence profile (ProfileID2). When the biometrically-authenticated wireless identification card thus configured according to Persona 3 comes into range of a transit system Bluetooth-enabled access point, the Bluetooth-enabled access point establishes a two-way Bluetooth communication session with the biometrically-authenticated wireless identification card and receives, from the identification card, data including TransitPass1 information. If User 2 authenticates to the biometrically-authenticated wireless identification card with their middle finger, for example after gaining access to a transit system, the identification card configuration module configures the biometrically-authenticated wireless identification card to transmit a personalized connectionless message with a PDU payload (3020) that include status=“distressed” using Bluetooth radio operating specifications specified by connectionless presence profile (ProfileID3). When the biometrically-authenticated wireless identification card thus configured according to Persona 4 comes into range of a transit system Bluetooth-enabled access point, the Bluetooth-enabled access point may parse a personalized connectionless message broadcast by the biometrically-authenticated wireless identification card and perform a particular action based on recognizing “distressed” status encoded in the personalized connectionless message. For example, the Bluetooth-enabled access point may notify a security function or emergency responders. In an exemplary embodiment, a user must authenticate with a first authenticate with a first authentication method to select a first persona prior to authenticating with a second authentication method to select a second persona. This two-step authentication is advantageous in that it prevents inadvertent selection of a second persona, for example selection of Persona 4 which includes a “distressed” status.

In a further exemplary embodiment, the Bluetooth-enabled access point performs one or more additional or alternative actions. The Bluetooth-enabled access point may establish a two-way Bluetooth communication session with the Bluetooth-enabled identification card and receive, from the biometrically-authenticated wireless identification card, Connect Payload (EmergencyInfo) which the Bluetooth-enabled access point may provide to a security or emergency response function. The EmergencyInfo may include information relevant to the “distressed” status, for example User 2 medical information, e.g., a severe allergy or dangerous heart condition of User 2. In another exemplary embodiment, the Bluetooth-enabled access point may access a customizable URL (e.g., URL3) that is included in the personalized connectionless message data packet. The customized URL may be configured to provide, to the Bluetooth-enabled access point, information, for example User 2's medical information.

### 6.9 Selecting Between Bluetooth and RFID for Different Types of Access

Referring once again to FIG. 1, an exemplary configuration of a Bluetooth-enabled biometrically-authenticated wireless identification card includes a Bluetooth radio and an RFID transmitter. A connectionless presence profile data store includes Bluetooth and RFID profiles which are each mapped to one or more personas. Each persona is mapped to a User/finger pair. Each connectionless presence profile is associated with one or more personas. When a particular persona is selected upon authentication using a corresponding user finger, Bluetooth radio and/or RFID transmitter are configured and operated according to a connectionless presence profile that is associated with the particular persona.

The identification card configuration module pulls, from the connectionless presence profile data store, a connectionless presence profile corresponding to the particular persona, which provides operating specifications of the RFID transmitter and Bluetooth radio. For example, a connectionless presence profile specifies activation of the RFID transmitter for 10 minutes to enable access to a physical resource that is controlled by a Bluetooth-enabled access control point that listens for, and responds to, RFID beacons. Another exemplary connectionless presence profile specifies activation of the Bluetooth radio, and transmission of a personalized connectionless message by the Bluetooth radio, to enable access to a resource, for example to a computer, that is controlled by a Bluetooth-enabled access control point that listens for and responds to BLE beacons.

In an exemplary embodiment, the biometrically-authenticated wireless identification card receives information, for example information encoded in a BLE advertising packet, from an access point without establishing a two-way connection with the access point. In a particular embodiment an access point broadcasts connectionless messages that each include identity information corresponding to a particular biometrically-authenticated wireless identification card that the access point has received a connectionless message from. The particular biometrically-authenticated wireless identification card processes information included in the connectionless message while other the biometrically-authenticated wireless identification cards and Bluetooth-enabled devices ignore the connectionless message.

connectionless messageconnectionless message An access point or connectionless presence profile specifies that the Bluetooth radio powers down when the biometrically-authenticated wireless identification card moves out of range of a Bluetooth radio of a Bluetooth-enabled access control point that is associated with the computer, for example when a beacon or communication signal transmitted by the access point is received by the identification card with less than a threshold received signal strength. The Bluetooth and RFID selection and configuration function of the biometrically-authenticated wireless identification card is advantageous over the known art. It allows a single biometrically-authenticated wireless identification card to be used for multiple types of wireless access control points and allows the single card to be configured for interaction with different instances of each of multiple types of access control points and access control systems, including systems controlled and provisioned by disparate entities.

### 6.10 Combined On-card and External Authentication

A high security entry point may request an additional biometric authentication from a user prior to establishing a one-to-one Bluetooth connection with a biometrically authenticated wireless identification device (1000, 4000, 5000) or once a Bluetooth connection has been established with the device. In this case, an external biometric authentication system associated with the high security entry point is used in combination with a biometric input device (1060) that is a component of a biometrically-authenticated wireless identification card. In an exemplary process flow, a user is successfully authenticated by the card-based biometric scanner, the biometrically-authenticated wireless identification card communicates personalized identifier data associated with the user to a high security entry point, and the user authenticates with the external biometric authentication device. The external biometric authentication device uses personalized identifier information provided by the biometrically-authenticated wireless identification card for comparison to data collected by the external biometric authentication device to make an authentication decision.

In a first exemplary arrangement in which the high security entry point requires external biometric authentication before establishing a Bluetooth connection with the biometrically-authenticated wireless identification card, the identification card transmits personalized identifier information in a personalized connectionless message comprising one or more advertising data packets. Personalized identifier information such as a photograph of a user, a face template, or an iris template are broken up into multiple data blocks and each data block transmitted by the biometrically-authenticated wireless identification card in one advertising packet of a chain comprising multiple advertising data packets or in an advertising packet and in one or more scan response packets. In a second exemplary arrangement in which the user is required to authenticate to the external biometric authentication device following establishment of a Bluetooth connection, the biometrically-authenticated wireless identification card transmits personalized identifier data to the high security access over the Bluetooth connection.

### 6.11 Exemplary Payment Terminal Interaction

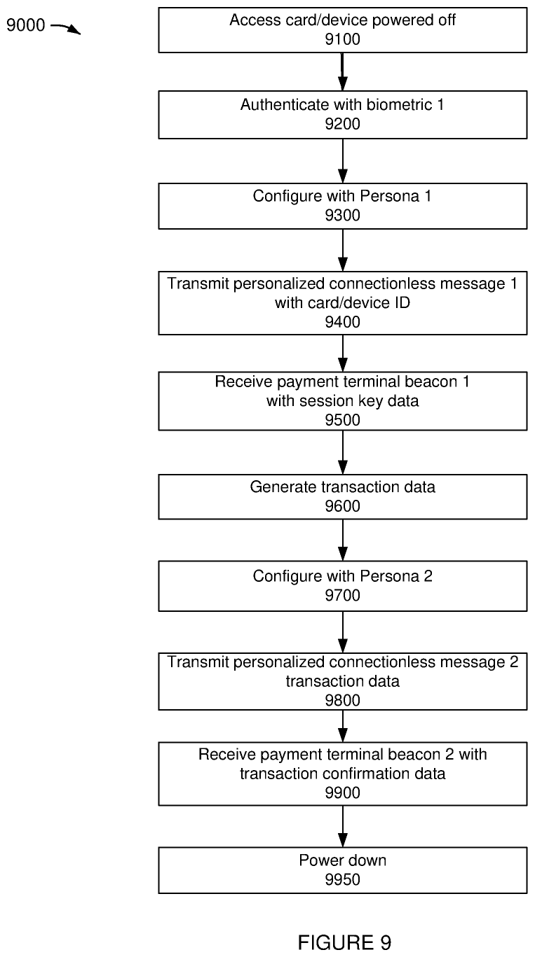

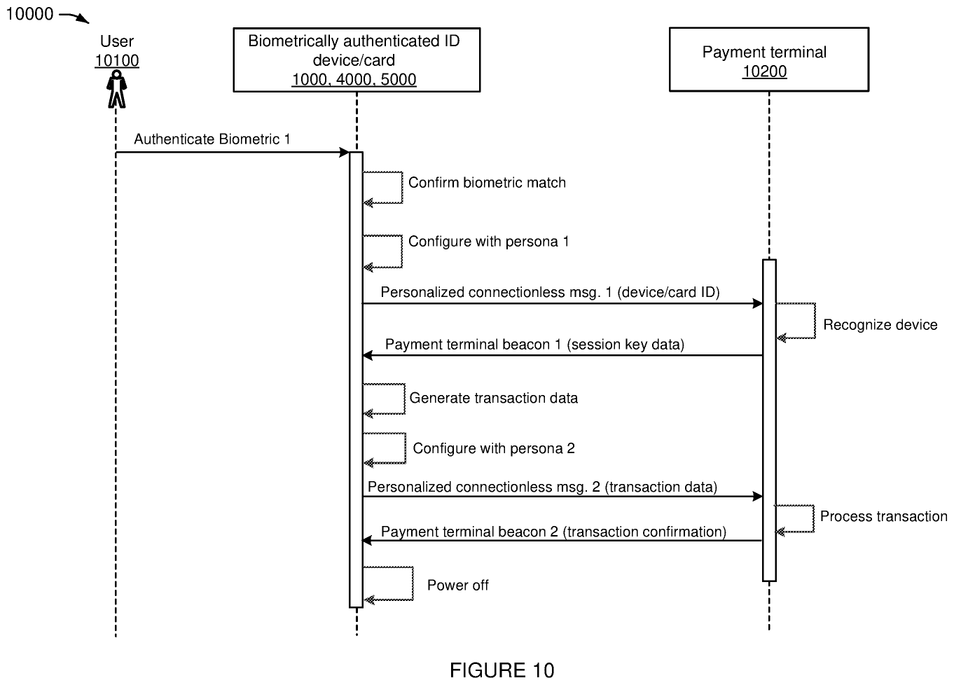

An exemplary embodiment of a biometrically authenticated wireless device is configured to complete a payment transaction with a wireless payment terminal by exchanging non-connectable connectionless message messages with the wireless payment terminal without establishing a one-to-one communication session with the wireless payment terminal. FIG. 9 illustrates an exemplary process flow (9000) for completing a connectionless message based payment transaction between a biometrically authenticated wireless device (1000, 4000, or 5000) and a wireless payment terminal (10200). FIG. 10 illustrates an exemplary information flow (10000) during the connectionless message based payment transaction.

Process (9000) begins with a biometrically authenticated wireless identification device (1000, 4000, or 5000) in a powered off state (9100). At step (9200), a user (10100) authenticates with a biometric input device (1060) of the biometrically authenticated wireless identification device using a first authentication method. In response, an identification device configuration module (1035) configures the biometrically authenticated wireless identification device with a first persona at step (9300). The first persona corresponds to the first authentication method. At step (9400), the biometrically authenticated wireless identification device begins transmitting a first personalized connectionless message, Beacon 1.

Beacon 1 comprises one or more biometrically authenticated wireless identification device identifier information such as a UUID, card serial number, MAC address, or payment account ID. The data content of Beacon 1 enables a payment terminal (10200) to recognize the biometrically authenticated wireless identification device.

When the payment terminal recognizes the biometrically authenticated wireless identification device, the payment terminal transmits a connectionless message that comprises session key data, which the biometrically authenticated wireless identification device receives at step (9500).

In response to receiving the session key data, the identification device configuration module generates transaction data using the session key data at step (9600). The identification device configuration module configures the biometrically authenticated wireless identification device with a second persona at step (9700). The identification device configuration module constructs a personalized connectionless message packet, Beacon 2, with a data payload that comprises the generated transaction data and loads the personalized connectionless message packet into the Bluetooth radio flash memory.

At step (9800), the biometrically authenticated wireless identification device transmits Beacon 2, which comprises the transaction data generated in step (9600). The payment terminal receives Beacon 2, including the transaction data, and processes the transaction. The payment terminal transmits a connectionless message that includes transaction confirmation data. The biometrically authenticated wireless device receives the connectionless message that includes transaction confirmation data at step (9900) and optionally powers down (9950) upon completion of the transaction.

In a further exemplary embodiment, the payment terminal may display a confirm purchase request and a user may be required to re-authenticate or otherwise interact with the biometrically authenticated wireless identification device to confirm a purchase or other payment transaction. In this embodiment, the user re-authenticates to the biometrically authenticated wireless identification device which then transmits a personalized connectionless message that include confirmation information. The described payment transaction process is advantageous in that it enables a transaction to be completed without establishing a one-to-one connection, thereby increasing transaction time and decreasing use of battery resources, thereby increasing battery life of the biometrically authenticated wireless identification device. The connectionless messages may be transmitted in the open but for only a short period of time, for example for 1 second or 2 seconds, thereby reducing security risk.

### 6.12 Transmitting Data Payloads in Multiple Personalized Connectionless Messages

Transmitting supplementary data such as identifiers including photographs and biometric templates via personalized connectionless messages is advantageous in that transmitting connectionless messages, as opposed to establishing and maintaining one-to-one communication sessions to deliver the supplementary, requires less power and preserves battery reserves of biometrically authenticated wireless identification devices.

In exemplary embodiments, a personalized connectionless message payload, for example personalized identifier information, includes a block of data that is too large to be included in a single beacon signal data packet. An exemplary biometrically authenticated wireless identification device breaks the personalized connectionless message payload into multiple sub-blocks and broadcasts each sub-block as payload data in each of multiple separate personalized connectionless message.

In an embodiment, each individual personalized connectionless message data packet comprising a sub-block of data includes a reference to one or more other data packets that each contains an additional sub-block of data from the same block of data. For example, a biometrically authenticated wireless identification device broadcasts multiple chained personalized BLE advertising data packets wherein a first advertising data packet in the chain references a second advertising data packet in the chain, the second advertising data packet references a third advertising data packet, etc.

In a second particular exemplary embodiment, the authenticated wireless identification device broadcasts a first personalized advertising data packet containing a first sub-block of data, in response, receives a scan request from a BT enabled device (e.g., a BT-enabled access control point) addressed to biometrically authenticated wireless identification device. The biometrically authenticated wireless identification device, in response to the scan request, transmits a scan response that includes a second sub-block of data. The biometrically authenticated wireless identification device continues receiving scan requests from the BT enabled device and sends scan responses to the BT enabled device wherein each scan response included an additional sub-block of data. When the biometrically authenticated wireless identification device has transmitted all sub-blocks of data to the BT enabled device, it responds to further scan requests with a scan response that indicates that no more sub-blocks of data are available for transmission, i.e. that an entire block of data has been transmitted.

Alternatively, a biometrically authenticated wireless identification device transmits a first personalized connectionless message that includes an indication that the biometrically authenticated wireless identification device is capable of providing, via beacon or other connectionless messages, data such as personalized identifier information. The biometrically authenticated wireless identification device may receive, from a BT enabled device in response to first personalized connectionless message, a connectionless request message (e.g., a BLE scan request data packet) that include a request the personalized identifier information. If the biometrically authenticated wireless identification device receives the connectionless request message, it responds with one or more connectionless response messages, e.g., one or more BLE scan request data packets, that each includes a portion of the personalized identifier information.

A biometrically authenticated wireless identification device can receive, from a BT enabled device, a connectionless message, for example a BLE scan request data packet, that includes a request for additional information from the biometrically authenticated wireless identification device.

### 6.13 Conclusions

It will also be recognized by those skilled in the art that, while the technology has been described above in terms of preferred embodiments, it is not limited thereto. Various features and aspects of the above described technology may be used individually or jointly. Further, although the technology has been described in the context of its implementation in a particular environment, and for particular applications (e.g. +++description+++), those skilled in the art will recognize that its usefulness is not limited thereto and that the present technology can be beneficially utilized in any number of environments and implementations where it is desirable to +++A, to B, to C, to D, to E+++. Accordingly, the claims set forth below should be construed in view of the full breadth and spirit of the technology as disclosed herein.

What is claimed:

1. A biometrically-authenticated identification device, comprising:
a processor;
a persistent memory;
a transient memory;
a persona data store comprising configuration or operational settings of the biometrically-authenticated wireless identification device;
a biometric input device;
a pre-enrolled biometric data store;
a biometric verification module in electronic communication with the biometric input device, the biometric verification module:
being configured to compare stored biometric indicia of a user of the biometrically-authenticated identification device with information provided by the biometric input device;
being in electronic communication with a pre-enrolled biometric data store; and
a wireless transceiver.

2. The biometrically-authenticated identification device of claim 1, wherein the biometrically-authenticated identification device is associated with:
one or more authentication methods; and
one or more biometric indicia provisioned for one or more specific authenticated users of the biometrically-authenticated identification device.

3. The biometrically-authenticated identification device of claim 1, wherein the biometrically-authenticated identification device comprises a plurality of the persona data stores.

4. The biometrically-authenticated identification device of claim 1, wherein the biometric input device comprises at least one of an iris scanner, a voice print recognizer, and a fingerprint scanner.

5. The biometrically-authenticated identification device of claim 1, wherein the wireless transceiver is a Bluetooth device, an RFID device, or both.

6. The biometrically-authenticated identification device of claim 1, wherein the wireless transceiver is an RFID transmitter and a Bluetooth radio.

7. The biometrically-authenticated identification device of claim 1, further comprising a personal connectionless message data store.

8. The biometrically-authenticated identification device of claim 7, wherein the biometrically-authenticated identification device is configured to transmit a personalized connectionless message.

9. The biometrically-authenticated identification device of claim 8, wherein the personalized connectionless message is transmitted wirelessly.

10. The biometrically-authenticated identification device of claim 8, wherein the personalized connectionless message is configured to indicate one or more of an authentication state of the biometrically-authenticated identification device, an authenticated user of the biometrically-authenticated identification device, and a state of the authenticated user.

11. The biometrically-authenticated identification device of claim 8, wherein the personalized connection message is configured according to a specific persona.

12. The biometrically-authenticated identification device of claim 11, wherein the persona is chosen according to a method of authentication chosen by an authenticated user.

13. The biometrically-authenticated identification device of claim 1, wherein the biometrically-authenticated identification device is dimensioned and configured to accept and communicate electronically with an identification card, the identification card providing biometric verification information such that a paring of the biometrically-authenticated identification device with the identification card confirms an identity of a holder of the paired biometrically-authenticated identification device and identification card.

14. A method for performing a secure electronic transaction using a biometrically-authenticated identification device, comprising:
authenticating an assigned user of the biometrically-authenticated identification device using a biometric identifier for the assigned user;
configuring the biometrically-authenticated identification device with a persona corresponding to the assigned user;
transmitting a personalized connectionless message using the biometrically-authenticated identification device; and
sending information to perform the secure electronic transaction.

15. The method of claim 14, wherein the biometrically-authenticated identification device is the biometrically-authenticated identification device of any of claims 1-13.

16. The method of claim 14, further comprising:
receiving key session data for the secure electronic transaction; and
generating transaction data corresponding to the secure electronic transaction.

17. The method of claim 14, further comprising:
configuring the biometrically-authenticated identification device with a second persona;
transmitting a personalized connectionless message using data associated with the second persona to perform a second secure electronic transaction; and
receiving data corresponding to the completion of the second secure electronic transaction.

18. The method of claim 14, wherein the biometrically-authenticated identification device is in an initial powered-down state, and further comprising powering the biometrically-authenticated identification device.

19. The method of claim 18, further comprising powering down the biometrically-authenticated identification device upon completing the secure electronic transaction.

20. The method of claim 14, wherein:
the assigned user authenticates using a first biometric indicia and generates a first connectionless message; and
the assigned user authenticates using a second biometric indicia and generates a second connectionless message, the first and second connectionless messages being different and indicating a status of the assigned user.
